(19) United States
(12) Patent Application Publication
(10) Pub. No.: US 2018/0032605 A1
(43) Pub. Date: Feb. 1, 2018

(54) INTEGRATED INTERMEDIARY COMPUTING DEVICE FOR DATA ANALYTIC ENHANCEMENT

(71) Applicant: PERSISTENT SYSTEMS LIMITED, Erandawana, Pune (IN)

(72) Inventors: Mukund Deshpande, Erandawane (IN); Sameer Dixit, Kothrud (IN); Dhruva Ray, Kothrud (IN); Vinayak Datar, Karve Nagar (IN)

(21) Appl. No.: 15/549,883

(22) PCT Filed: Feb. 10, 2016
(86) PCT No.: PCT/IB16/50711

§ 371 Date: Aug. 9, 2017

Related U.S. Application Data
(60) Provisional application No. 62/131,007, filed on Mar. 10, 2015.

(30) Foreign Application Priority Data
Feb. 18, 2015 (IN) 466/DEL/2015

(51) Int. Cl. G06F 17/30

(52) U.S. Cl. CPC G06F 17/30696; G06F 17/3066; G06F 17/30716

(57) ABSTRACT

An intermediary computing device, and related methods, that enhance data analytics operations are provided. An analytics platform appliance associated with the intermediary computing device can obtain and parse a flow text file data structure to identify a transactional source system. A data extraction mechanism can obtain, from the transactional source system and based on information in the flow text file data structure, a source data structure. A data transform mechanism can generate, based on information in the flow text file data structure, a data model structure from the source data structure. The analytics platform appliance can identifies, from the flow text file data structure, presentation data instructions. A data load mechanism can access the data model structure create a display data structure based on the presentation data instructions. The intermediary computing device can provides the display data structure to the end user computing device.

### CROSS-REFERENCES TO RELATED APPLICATIONS

This application claims the benefit of priority of U.S. provisional application 62/131,007, filed Mar. 10, 2015 and titled “Systems and Methods of Providing Data Analytics in a Computer Networked Environment” and to Indian provisional application 466/DEL/2015, filed Feb. 18, 2015 and titled “Systems and Methods of Providing Data Analytics in a Computer Networked Environment”, each of which is incorporated by reference herein in its entirety.

### BACKGROUND

Server based computer architectures can analyze data in proprietary or other data formats to identify predictive or descriptive conclusions from large volumes of data. These volumes of data can include different pieces of data in different forms, from different sources, and the volumes of data can change with time.

### SUMMARY

At least one aspect is directed to an intermediary computing device that enhances data analytics operations. The intermediary computing device can be disposed in a data communications path between a transactional source system and an end user computing device. The intermediary computing device can include an analytics platform appliance that includes a data extraction mechanism, a data transform mechanism, and a data load mechanism. The analytics platform appliance can obtain, from the end user computing device, a flow text file data structure. The analytics platform appliance can parse the flow text file data structure to identify the transactional source system. The data extraction mechanism can obtain, from the transactional source system and based on information in the flow text file data structure, a source data structure. The data transform mechanism can generate, based on information in the flow text file data structure, a data model structure from the source data structure and can store the data model structure in a database. The analytics platform appliance can identify, from the flow text file data structure obtained from the end user computing device, presentation data instructions. The data load mechanism can access the data model structure from the database and can create a display data structure based on the presentation data instructions identified from the flow text file data structure. The intermediary computing device can provide the display data structure to the end user computing device.

At least one aspect is directed to a method of enhancing data analytics operations with an intermediary computing device. The intermediary computing device can include an analytics platform appliance and that is disposed in a data communications path between a transactional source system and an end user computing device. The method can obtain, by the analytics platform appliance, from the end user computing device via the data communications path, a flow text file data structure. The method can identify, by the analytics platform appliance, from the flow text file data structure, the transactional source system. The method can obtain, by the intermediary computing device, from the transactional source system and based on information in the flow text file data structure, a source data structure. The method can generate, by the intermediary computing device, based on information in the flow text file data structure, a data model structure from the source data structure and can store the data model structure in a database. The method can identify, by the intermediary computing device, from the flow text file data structure, presentation data instructions. The method can access the data model structure from the database to create a display data structure based on the presentation data instructions identified from the flow text file data structure. The method can provide, by the intermediary computing device, the display data structure to the end user computing device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example environment to enhance data analytics operations, according to an illustrative implementation;

FIG. 2 is a functional diagram depicting one example environment to enhances data analytics operations, according to an illustrative implementation;

FIG. 3 is an example illustration of a display in an enhanced data analytics operations environment, according to an illustrative implementation;

FIG. 4 is an example illustration of a display in an enhanced data analytics operations environment, according to an illustrative implementation;

FIG. 5 is an example illustration of a display in an enhanced data analytics operations environment, according to an illustrative implementation;

FIG. 6 is an example illustration of a display in an enhanced data analytics operations environment, according to an illustrative implementation

FIG. 7 is a flow diagram depicting an example method of enhancing data analytics operations, according to an illustrative implementation; and

FIG. 8 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, devices, methods, apparatuses, and systems of enhancing data analytics operations via at least one intermediary computing device that extracts information from a flow text file data structure to integrate transactional source system data that can include heterogeneous or multi-format data into a structured format, for example. The flow text file data structure can be obtained by the intermediary device from an end user computing device. The intermediary computing device can, for example, perform extract, transform, or load operations via different operations, in different formats, on different forms of data responsive to an evaluation of declarative text obtained from the flow text file data structure. The intermediary computing device can provide output data (e.g., a display data structure) for display by the end user computing device where, for example, the only input received by the intermediary computing device from the end user computing device used to effect the display is contained in the flow text file data structure. The various concepts introduced above and discussed in greater detail below may be implemented in any of numerous ways.

Devices, systems and methods of the present disclosure relate generally to an intermediary computing device for integrated data analytics operations. Data analytics tools can be specialized for particular data analytics operations; such as data acquisition, storage, modelling, or reporting. These different data analytics operations can require or use different applications that may benefit from specialized or proprietary knowledge. For example, the intermediary computing device can perform data extraction using extract, transform or load (ETL) tools or data connectors such as Talend™ or Informatica™ or other data integration or management applications. The intermediary computing device can perform data modeling operations using Databases or Hadoop Distributed File System (HDFS) or NOSQL Databases. The intermediary computing device can perform reporting or dashboarding operations using visualization applications such as those available from Tableau™, JasperReports or other reporting tools.

The intermediary computing device can, for example, provide a browser based dashboard display for rendering at the end user computing device. The end user computing device can receive as input (from an end user) a flow text file data structure. The intermediary computing device can analyze or execute the flow text file data structure to generate, call, or implement multiple different applications that can perform the various data analytics operations noted above, such as data acquisition, storage, modelling, or reporting. In this example, the intermediary computing device performs the varied analytics operations based exclusively on the flow text file data structure to provide a desired result for rendering (e.g., in a browser interface) of the end user computing device. The end user in this example can only provide the flow text file data structure and need not have the specialized, varied or proprietary knowledge that may be necessary to perform the multi-faceted data analytics operations used to convert heterogeneous unstructured or semi-structured data into a structured display.

The intermediary computing device that operates based on the flow text file data structure described herein can make integrated optimization decisions across data extraction, data model structure, transformation mechanism and presentation data instructions, providing a technical solution that solves technical problems that arise when these structures are developed in isolation. Also, the ability to perform the extraction, modeling, or presentation operations described herein is not limited to a particular technology stack. As technology evolves, the intermediary computing device can adapt to future technologies with backward compatibility to existing technology stack. This can reduce or eliminate migration needs across devices, systems, or platforms. As technology evolves, the flow text file data structure described herein can still generate instructions for data analytics that involves newer technologies.

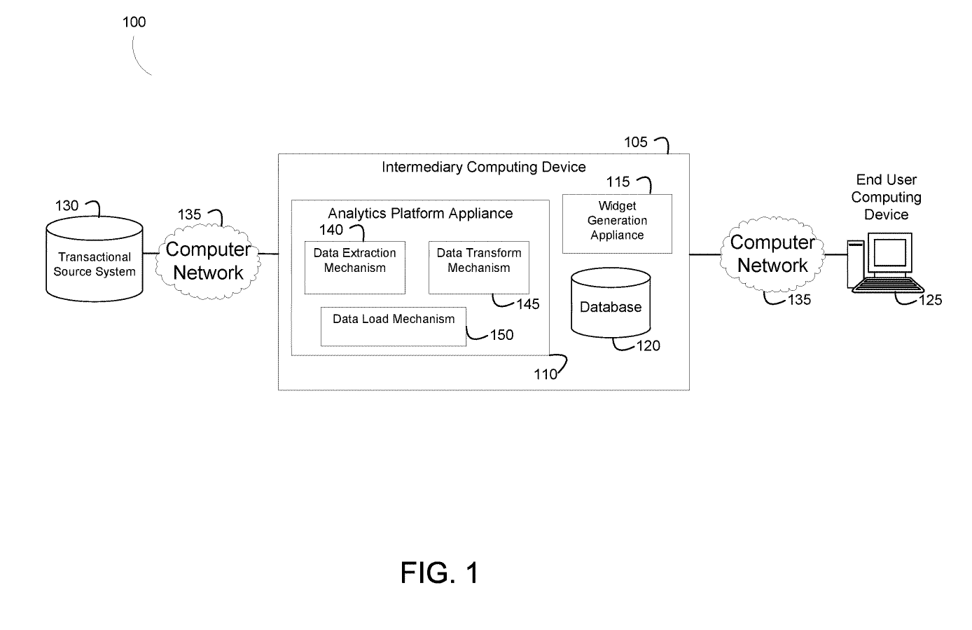

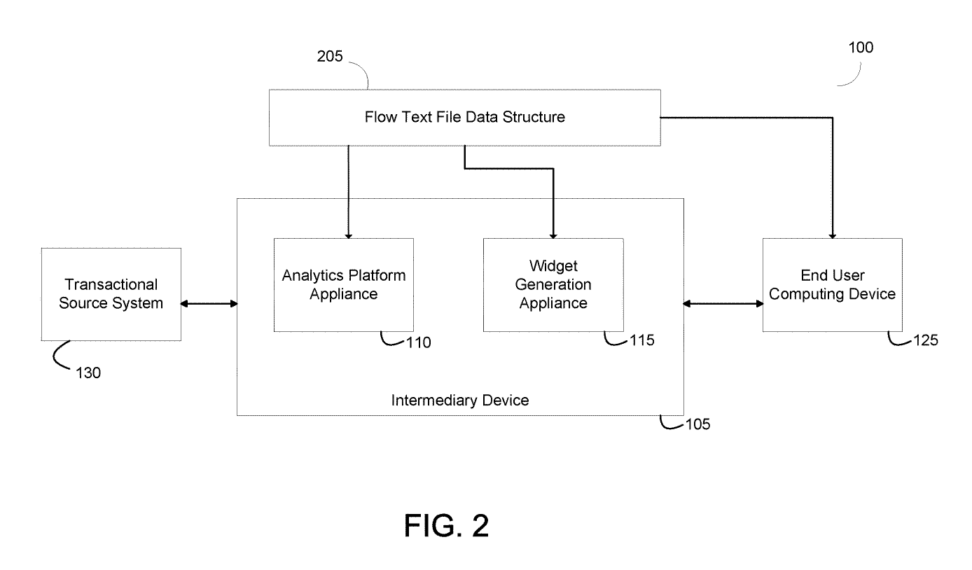

FIG. 1 illustrates an example system 100 to enhance data analytics operations. FIG. 2 illustrates a functional diagram depicting one example of the system 100 to enhance data analytics operations. The system 100 can be part of a data analytics enhancement system that, for example, integrates a single flow text file data structure 205 into a multi-application data analytics environment to provide a structured representation of data from source data structures in one or more various formats or of one or more different types. The system 100 includes at least one intermediary computing device 105. The intermediary computing device 105 can include at least one server. For example, the at least one intermediary computing device 105 can include a plurality of servers located in at least one data center or server farm. The intermediary computing device 105 can obtain and parse the flow text file data structure 205 to perform, for example, extract, transfer, load, store, or display operations. The intermediary computing device 105 can include at least one analytics platform appliance 110, at least one widget generation appliance 115, and at least one database 120.

The analytics platform appliance 110 and the widget generation appliance 115 can each include at least one processing unit, server, virtual server, circuit, agent, appliance, or other logic device such as programmable logic arrays configured to communicate with the database 120 and with other computing devices (e.g., end user computing devices 125 or computing devices of the transactional source system 130) via the computer network 135.

The system 100 can include at least one computer network 135. The computer network can include computer networks such as the internet, local, wide, metro, virtual private, or other area networks, intranets, satellite networks, other computer networks such as voice or data mobile phone communication networks, and combinations thereof. The intermediary computing device 105 can include at least one hardware logic device such as a computer, special purpose computer, mainframe computer, virtual computer, or server having a processor to communicate via the network 135, for example with at least one end user computing device 125 or with at least one transactional source system 130.

The analytics platform appliance 110 and the widget generation appliance 115 can include can include at least one hardware logic device such as a computer, special purpose computer, or server having a processor, such as hardware of the intermediary computing device 105. The analytics platform appliance 110 and the widget generation appliance 115 can include or execute at least one computer program or at least one script. The analytics platform appliance 110 and the widget generation appliance 115 can be separate components, a single components, or part of one or more than one intermediary computing devices 105. The analytics platform appliance 110 and the widget generation appliance 115 can include combinations of software and hardware, such as one or more processors configured to obtain or parse flow text file data structures 205, obtain source data structures, generate model data structures, identify presentation instructions, or create or provide display data structures, for example.

The system 100 can include at least one end user computing device 125. The end user computing devices 125 can include personal computers, servers, mobile computing devices, or other computing devices operated by an end user to, for example create flow text file data structures 205, provide flow text file data structures 205 to the intermediary computing device 105, or to receive or display the display data structures received from the intermediary computing device 105 via the computer network 135. For example, the end user computing device 125 can open or execute a browser program that can display a browser interface dashboard. The browser interface dashboard can receive as input from the end user the flow text file data structure 205. The end user computing device 125 can provide the flow text file data structure 205 via the computer network 135 to the intermediary computing device 105. The end user computing device 125 can locally execute one or more applications or scripts to render the browser interface dashboard, or the intermediary device 105 (or component thereof such as the analytics platform appliance 110) can execute one or more applications or scripts (e.g., a browser interface dashboard application) to remotely render the browser interface dashboard at the end user computing device 125.

The end user computing devices 125 can communicate with the intermediary computing devices 105 to receive display data structures and to provide displays on a monitor or other output device. The end user computing devices 125 can include desktop computers, laptop computers, tablet computers, smartphones, personal digital assistants, mobile devices, mainframe computing devices, special purpose computers, consumer computing devices, servers, clients, and other computing devices. The end user computing devices 125 can include user interfaces such as microphones, speakers, touchscreens, keyboards, pointing devices, a computer mouse, touchpad, or other input or output interfaces.

The system 100 can include or communicate with at least one transactional source system 130. The transactional source system 130 can include one or more servers computing devices, or databases (or other data storage devices). The transactional source system 130 can include third party data sources or other sources of data, and can include open or publically available data sources, closed or proprietary data sources, or streaming data sources. The transactional source systems 130 can include data in various formats, as well as structured data, unstructured data, or semi-structured data. For example, structured data can include .csv files, XML files, or a result set of a query. Semi-structured data can include HTML web pages, or other data sets where there can be structure of some form but that can also include a degree of irregularity in the structure. Unstructured data can include electronic documents, articles, or an unstructured data set. Relative to structured and semi-structured data, unstructured data can be text heavy.

In addition to identifying, evaluating, analyzing or obtaining various formats of source data from the transactional source system 130, the data extraction mechanism 140 can also consider or perform extraction operations based on the grain of the extraction. For example, the data extraction mechanism 140 can extract entire historical data, partial date range date, incremental feed of the data, newly arrived data, or continuously streaming data, for example. The intermediary computing device 105 hosting a data analytics platform (e.g., the analytics platform appliance 110 and the widget generation appliance 115, can support any such forms of load characteristics as well.

The system 100 can include at least one data extraction mechanism 140, at least one data transform mechanism 145, or at least one data load mechanism 150. The data extraction mechanism 140, data transform mechanism 145, and data load mechanism 150 can be part of, or can include scripts executed by, the intermediary computing device 105 or one or more servers or computing devices thereof. The analytics platform appliance 110 can include the data extraction mechanism 140, the data transform mechanism 145, or the data load mechanism 150. The data extraction mechanism 140, data transform mechanism 145, and data load mechanism 150 can include hardware (e.g., servers) software (e.g., program applications) or combinations thereof (e.g., processors configured to execute program applications) and can execute on the intermediary computing device 105 or the end user computing device 125.

The intermediary computing device 105 can be disposed in a data communications path between the transactional source system 130 and the end user computing device 125. For example, the intermediary computing device 105 can reside in one or more data centers and can communicate with the transactional source system 130 and with the end user computing device 125 via the computer network 135 (e.g., an area network or the internet).

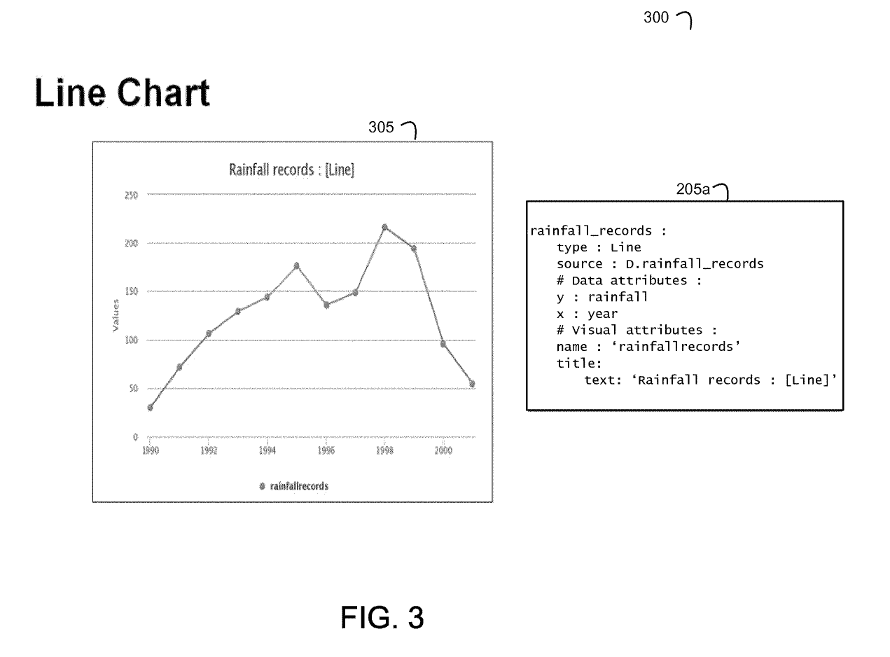

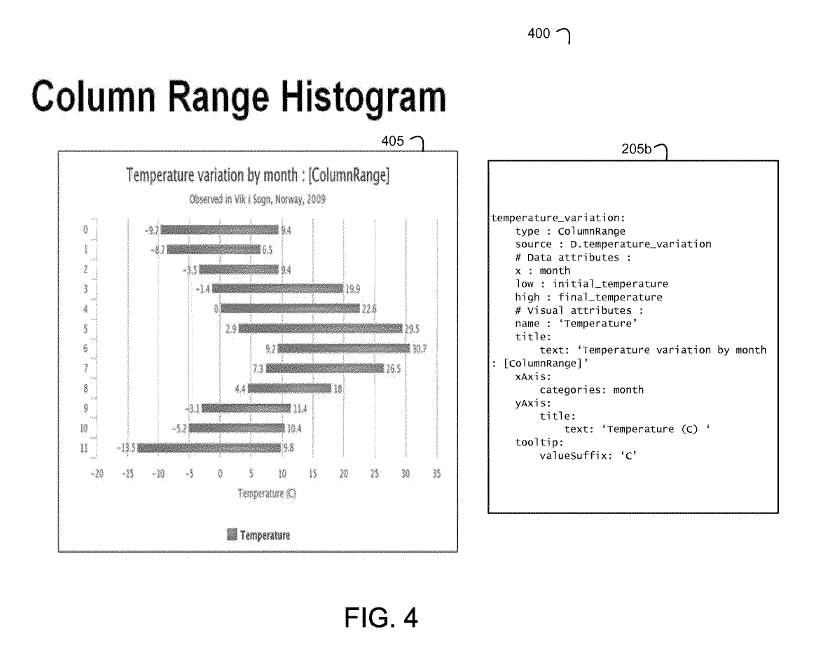

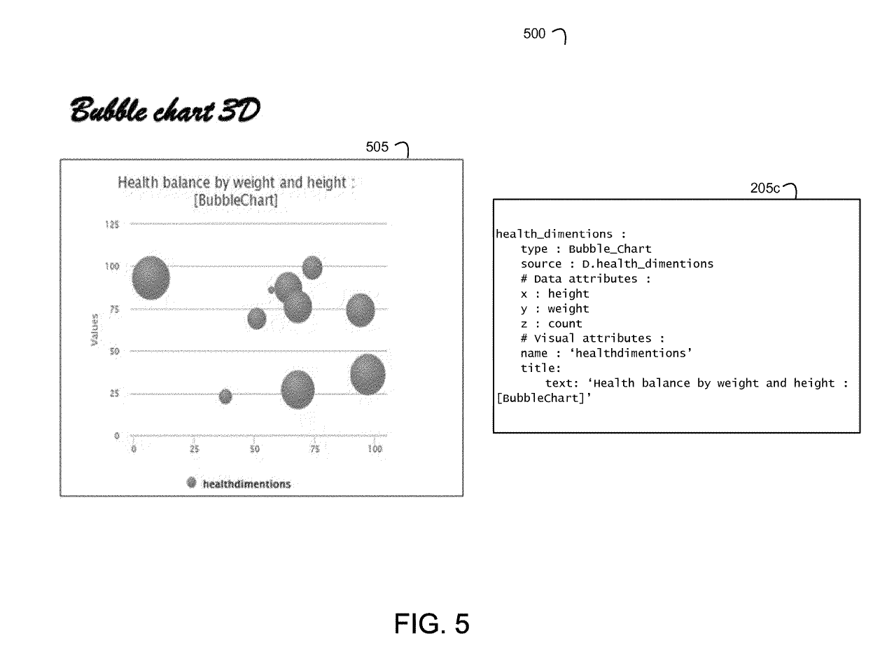

FIG. 3 depicts an example illustration of a view 300 in an enhanced data analytics operations environment. FIG. 4 depicts an example illustration of a view 400 in an enhanced data analytics operations environment. FIG. 5 depicts an example illustration of a view 500 in an enhanced data analytics operations environment. Referring to FIGS. 1-6, among others, the analytics platform appliance 110 can obtain a flow text file data structure 205. For example, via the computer network 135, the analytics platform appliance 110 can establish a communication session with the end user computing device 125. In some implementations, the analytics platform appliance 110 can execute a data analytics enhancement program to provide a browser interface dashboard for display by the end user computing device 125. The browser interface dashboard can be displayed within a browser program of the end user computing device 125. An end user can input commands or data into an interface of the browser interface dashboard to cause the end user computing device 125 to generate the flow text file data structure 205. The flow text file data structure 205 can include declarative commands, for example in a human readable data serialization programming language such as YAML. In this example, the end user operates the end user computing device to create the flow text file data structure 205. The end user computing device 125 can transmit the flow text file data structure 205 via the network 135 to the intermediary computing device 105, where can be received, obtained, or accessed by the analytics platform appliance 110. The analytics platform appliance 110 can provide the flow text file data structure 205 to the database 120 for storage.

For example, referring to FIG. 3, among others, the view 300 can be part of the browser interface dashboard can be displayed within a browser program of the end user computing device 125 and can include the flow text file data structure 205a, e.g., a YAML file data structure having declarative commands to obtain a structured representation of rainfall records over a period of time. The example flow text file data structure 205a is reproduced below:

```
rainfall_records :
      type : Line
      source : D.rainfall_records
      # Data attributes :
      y : rainfall
      x : year
      # Visual attributes :
      name : ‘rainfallrecords’
      title:
            text: ‘Rainfall records : [Line]’
```

The flow text file data structure 205a in this example includes declarative text to obtain source data regarding rainfall statistics for year long time periods; and to prepare a visual line chart display indication of rainfall data in a display having the title “Rainfall records: [Line]”. The intermediary computing device 105 (or component thereof such as the analytics platform appliance 110) can obtain the flow text data structure 205a from the end user computing device 125 via the computer network 135.

The analytics platform appliance 110 can parse (e.g., evaluate, or analyze) the flow text file data structure 205 to identify at least one transactional source system 130. For example, the analytics platform appliance 110 can determine from the flow test file data structure 205a that the transactional source system 130 includes an identified rainfall records database, (e.g., “D.rainfall_records”).

The analytics platform appliance 110 (or component thereof) can obtain at least one source data structure. For example, the data extraction mechanism 140 can access or retrieve source data structures from one or more databases or memory units associated with the transactional source system 130. In the example of FIG. 3, this may include unstructured, semi-structured, or structured data regarding rainfall amounts during various calendar years. The data extraction mechanism 140 or other intermediary computing device 105 component can provide the source data structures to the database 120 for storage. The source data structure can include multiple heterogeneous data structures.

The flow text file data structure 205 can include a plurality of different files, sub-files, data structures, or components. For example, during one or more communication sessions or instances between the intermediary computing device 105 and the end user computing device 125, the analytics platform appliance 110 can obtain a plurality of different flow text file data structures that collectively form the flow text file data structure 205. For example, the analytics platform appliance 110 can provide a prompt for information or for more information for display within a browser interface dashboard application rendered at the end user computing device 125. In response, the end user computing device 125 can receive input declarative commands from an end user into an interface of the browser interface dashboard that collectively part of the flow text file data structure 205. In this and other examples, the analytics platform appliance 110 obtains the flow text file data structure 205 via a browser interface dashboard of the end user computing device 125.

The analytics platform appliance 110 (or component thereof) can generate at least one data model structure. For example, the data transform mechanism 145 can generate the data model structure from the source data structure. In some implementations, the data extraction mechanism 140 (or other component) can obtain one or more source data structures from the transactional source system 130. The source data structure includes a plurality of heterogeneous data structures. In some implementations, the data extraction mechanism 140 obtains the source data structure that includes a first heterogeneous data structure in a first format, and that includes a second heterogeneous data structure in a second format. The data transform mechanism 145 (or other component) can generate, from information in the text file data structure 205, the data model structure.

The data transform mechanism 145, based on the information in the text file data structure 205, the data model structure, or the presentation data instructions, can execute either on the intermediary computing device 105 or on the end user computing device 125. The data transformation mechanism 145 can allow the end user to extend existing operators or create new operators that the system 100 or that the intermediary computing device 105 (e.g., the analytics platform) does not provide. The intermediary computing device 110 can ensure that these extensions work in multiple execution environments.

Based on the flow text file data structure 205, the analytics platform appliance 110 can generate transformations (e.g., Filterby, Groupby, Condition, Join or other operations) that convert data from one form to another. The analytics platform appliance 110 can create the data model from the converted form of data. For example, the data model can be based on a Hadoop distributed file system (HDFS) hive data model or Database based data model, based on the information indicated by the flow text file data structure 205.

For example, consider the following two data sources (e.g., from one or more transactional source systems 130):

```
D:
      lang_greeting : [language, greeting(string)]
      lang_family : [language, greeting(string)]
```

The analytics platform appliance 110 (or other component) can implement the following transformations to convert these data sets into a new data model:

```
      F:
            +D.all_origins : D.lang_family | T.
            groupby_get_distinct_origins
            +D.greetings_with_origin : (D.
            lang_greeting, D.lang_family) |
T.join_toadd_origin
```

In this example, D.all.origins and D.greetings_with_origin are new datasets created, e.g., by the intermediary computing device 105 after the transformation. The analytics platform appliance 110 can create the data model in a determined technology stack (e.g., Apache Hive over HDFS, or databases, database warehouse, or similar structures) based on the flow text file data structure 205.

The data model can include a structured or ordered representation of at least some of the data obtained from the source data structure. Components of the intermediary computing device 105 such as the analytics platform appliance 110 (or other components thereof) can evaluate data of the flow text file data structure 205 that is in a first format (e.g., YAML) and can generate, from the flow text file data structure 210, at least one executable instruction in a second format, such as a non-declarative format. The data transform mechanism 145 can provide the data model structure to the database 120 for storage by the database 120. For example, the analytics platform appliance 110 can select a type of data storage for the data model structure based on characteristics of the data model structure.

The flow text file data structure 205 can include presentation data instructions. The presentation data instructions can indicate a type of presentation to provide to the ned user computing device 125 for display. For example, the flow text file data structure 205a can include presentation data instructions to provide a line chart display of rainfall records, e.g., “type:Line”. The analytics platform appliance 110 or the widget generation appliance 115 can identify the presentation data instructions from the flow text file data structure 205. Some example presentation data instructions include instructions to provide structured data representations (e.g. widget selections) in the form of area charts, 2D pie charts, 3D pie charts, doughnut charts, area range charts, logarithmic line graph charts, pyramid charts, bar charts, area spline range charts, funnel charts, waterfall charts, spline charts, scatter plots, line charts, column range histograms, error range bar charts, box plot charts, area spline charts, heat maps, bubble charts, 2D bubble charts, 3D bubble charts, column bar graphs, histograms, 2D stacked column charts, 3D stacked column charts, word clouds, maps, map marker charts, dendrograms, tree branch charts, parallel coordinate plot charts, stacked area charts, spark line charts, date or slider charts, scatter plot matrix charts, data tables, Sankey diagrams, multi series plots, 3D stacked column graphs, multipolar graphs, solid gauge graphs, streamgraphs, polar graphs, sparkline plots, timeline plots, filter buttons, grid tables, event line plots, 3D scatter plots, windrose plots, other plots, charts, or graphs, or combinations thereof. These and other charts, graphs, or plots can be referred to herein as widgets.

The presentation data instructions can identify at least one widget to use for visualization, what datasets can be attached to each widget, how each widget can get laid out or displayed on the browser of the end user computing device 125, and what interactions are possible on the widget and across various widgets. The flow text file data structure 205 can provide or indicate all of these instructions. Based on the instructions e.g., in the flow text file data structure 205, the analytics platform appliance 110 can load the data model, generate the appropriate visualization or display, perform data transformation or interactions, and render the display of the display data structure and widget within the browser of the end user computing device 125.

The analytics platform appliance 110 or component thereof such as the data load mechanism 150 can access the data model structure (e.g., from the database 120) and can create a display data structure (e.g., instructions that render a line chart) or other display associated with the presentation data instructions identified from the flow text file data structure 205. The widget generation appliance 115, which can be part of the analytics platform appliance 110 or a separate component, can create or generate the display data structure corresponding to the structured data representations (e.g., widget selections—charts, plots, graphs, or tables) discussed herein. For example, the display data structure (or associated display) can include a combination of HTML, JavaScript or CSS. The HTML can provide the structures to the dashboard or widgets (e.g., a line chart, pie chart, or heat map, among others). The widget generation appliance 115 can run as in-memory java script based OLAP cube (e.g., an online analytical processing multi-dimensional data array) in the browser and can load the data into the HTML Widgets. The in-memory OLAP cube also provides ability to parse the data to provide for interactions among widgets.

In some implementations the data load mechanism 150 (or other component such as the data transform mechanism 145) executes instructions, e.g., from the data model structure, in a non-declarative format to generate or create a display data structure. For example, the analytics platform appliance 110 can create or generate the display data structure from the data model structure, where the data structure was created from underlying heterogeneous source data structures having different formats. In this and other examples the data model structure includes a structured format representation of information obtained from the source data structure. The source data structure can include heterogeneous data in more than one different format.

Thus, for example, an end user with the end user computing device 125 can create the text file data structure 205 and from this one text file data structure (that may or may not include sub files) the intermediary computing device 105 can generate instructions in different formats to access source data structures of the transactional source system 130, extract source data structures, and generate a data model structure. The intermediary device 105 can use the data model structure to create at least one display data structure based on presentation data instructions of the text file data structure 205. The intermediary computing device 105 can provide the display data structure to the end user computing device 125 to effect presentation of a chart, graph, or other display as called for in the flow text file data structure 205. In this example, the end user need not parse or provide instructions in anything other than a declarative format such as YAML (the text file data structure 205), and the intermediary device 105 can, from the YAML or other declarative instructions, source appropriate unstructured data from one or more sources in one or more formats, organize it into a structured format, and provide a display for rendering by the end user computing device 125.

The intermediary device 105 can provide the display data structure to the end user computing device 125 (e.g., via the computer network 130) for display be the end user computing device 125. The display data structure can be part of a program executed by the analytics platform appliance 110 or by the widget generation appliance 115 at the intermediary computing device 105 where the output (e.g., a chart or graph) is provided via the computer network 135 for display; or part of a program that can be executed locally by the end user computing device 125 to generate the display rendered, e.g., within a browser interface dashboard, by the end user computing device 125.

The end user computing device 125 can render the display data, such as a visual, audio, or text representation of the display data structure. For example, the intermediary computing device 105 can remotely execute one or more applications that include the display data structure to provide the output display for rendering by the end user computing device 125. In some implementations, the end user computing device 125 installs and locally executes one or more applications to effect rendering of a display of the display data structure.

Referring to FIGS. 3-6, among others, the view 300 can include at least one display 305. For example, the display 305 includes a line chart that depicts rainfall records for years that include the period from 1990 until after the year 2000. The display 305 is an example of structured information generated by the intermediary computing device 105 and rendered at the end user computing device 125. From the end user point of view at the end user computing device 125, the end user interfaces with the end user computing device 125 to generate the flow text file data structure 205a. The intermediary computing device 105 can obtain unstructured source data structures in various formats, and from this information the intermediary computing device 105 provides a display data structure to cause rendering of the display 305 at the end user computing device 125. In this example, the end user does not see, and the end user computing device 125 does not use memory or processing power to perform the high data volume cross format operations to identify the transactional source system 130, obtain the source data structure, generate the model data structure, or create the display data structure. Instead, in this example, the end user computing device 125 provides a (for example declarative) text file data structure 205a, and in response the display 305 is rendered to the end user, for example in a browser based dashboard interface. Instead, the above operations are executed by the intermediary computing device. In this example, the end user computing device 125 can execute (e.g., only) a browser program, and does not download or execute any data analytics based applications. In some implementations, the display (e.g., display 305) can be rendered at the end user computing device 125 concurrent, adjacent, or in juxtaposition with the text file data structure 205 so that both can be visible to the end user. For example, the intermediary computing device 105 can cause rendering at the end user computing device 125 of the display 305 and the text file data structure 205 so that the display 305 and the text file data structure 205 do not overlap.

The analytics platform appliance 110 can use a Hadoop ecosystem for scalability. Thus, the systems, devices, appliances, and mechanisms described herein can scale to perform data analytics applications on terabytes or petabytes of data, for example by including sufficient hardware in the intermediary computing device(s) 105. The analytics platform appliance 110 does not have an upper limit on the volume of the data that can be processed by the systems, methods, devices and other components described herein.

The analytics platform appliance 110 can perform single mode processing, cluster mode processing, batch mode processing or real time processing operations. For example, based on the flow text file data structure 205, the analytics platform appliance 110 can make decisions and execute the transformations in any of these modes. The execution time can vary from less than one second for real time processing, to several hours or several days (e.g. 8 hours or 6 or fewer days) for large volume (e.g., at least one terabyte), complex distributed transformations based on the nature of the data and the analytics involved.

FIG. 4 depicts the example view 400 that includes the text file data structure 205b (e.g., a YAML file data structure) and the display 405. In this example, the end user with declarative programming language capabilities can provide input to the end user computing device 125 to create the text file data structure 205b that calls for a structured representation of temperature variation by month, e.g., in the form of a column range histogram (e.g., the display 405).

At least part of the view 400, such as the display 405 or the text file data structure 205b, can be part of the browser interface dashboard can be displayed within a browser program of the end user computing device 125 and can include the flow text file data structure 205b, e.g., a YAML or other declarative file data structure having declarative commands to obtain a structured representation of temperature variation by month. The example flow text file data structure 205b is reproduced below:

```
temperature_variation:
      type : ColumnRange
      source : D.temperature_variation
      # Data attributes :
      x : month
      low : initial_temperature
      high : final_temperature
      # Visual attributes:
      name : ‘Temperature’
      title:
            text: ‘Temperature variation by month: [ColumnRange]’
      xAxis:
            categories: month
      yAxis:
            title:
                  text: ‘Temperature (C)’
      tooltip:
            valuesuffix ‘C’
```

The flow text file data structure 205b (and other flow text file data structures 205) in this example includes declarative text to obtain source data structures that indicate temperature variation by monthly time periods (the source data structures can include unstructured, semi-structured, or structured data, and can be in various formats). The flow text file data structure 205b (and other flow text file data structures 205) can also include declarative text (e.g., a widget selection or presentation data instructions) to prepare a column range histogram chart display 405 as a structured representation of temperature range variation by month having the name “Temperature” and the title “Temperature variation by month: [ColumnRange]”. The intermediary computing device 105 (or component thereof such as the analytics platform appliance 110) can obtain the flow text data structure 205b from the end user computing device 125 via the computer network 135, perform data analytics operations from unstructured or various source data structures, (e.g., from the transactional source system 130 that includes a database “D.temperature_variation”) and generate a display data structure that causes rendering of the display 405 at the end user computing device 125.

FIG. 5 depicts the example view 500 that includes the text file data structure 205c (e.g., a YAML file data structure) and the display 505. In this example, the end user with declarative programming language capabilities can provide input to the end user computing device 125 to create the text file data structure 205c that calls for a structured representation of height and weight health dimensions by month, e.g., in the form of a 3D bubble chart (e.g., the display 505).

At least part of the view 500, such as the display 505 or the text file data structure 205c, can be part of the browser interface dashboard can be displayed within a browser program of the end user computing device 125 and can include the flow text file data structure 205c, e.g., a YAML or other declarative file data structure having declarative commands to obtain a structured representation of height and weight. The example flow text file data structure 205c is reproduced below:

```
health_dimensions:
      type : Bubble_Chart
      source : D.health_dimensions
      # Data attributes :
      x : height
      y : weight
      z : count
      # Visual attributes :
      name : ‘health dimensions’
      title:
            text: ‘Health balance by weight and height: [BubbleChart]’
```

The flow text file data structure 205c (and other flow text file data structures 205) in this example includes declarative text to obtain source data structures that indicate health variation by weight and height. Any source data structures can include unstructured, semi-structured, or structured data, and can be in various formats. The flow text file data structure 205c (and other flow text file data structures 205) can also include presentation data instructions (e.g., a widget selection or declarative text) to prepare a 3D bubble chart display 505 as a structured representation of weight and height health variations having the name “healthdimensions” and the title “Health balance by weight and height: [BubbleChart]”. The intermediary computing device 105 (or components thereof such as the analytics platform appliance 110 or the widget generation appliance 115) can obtain the flow text data structure 205c from the end user computing device 125 via the computer network 135, perform data analytics operations from unstructured or various source data structures, (e.g., from the transactional source system 130 that includes a database “D.health_dimensions”) and generate a display data structure that causes rendering of the display 505 at the end user computing device 125.

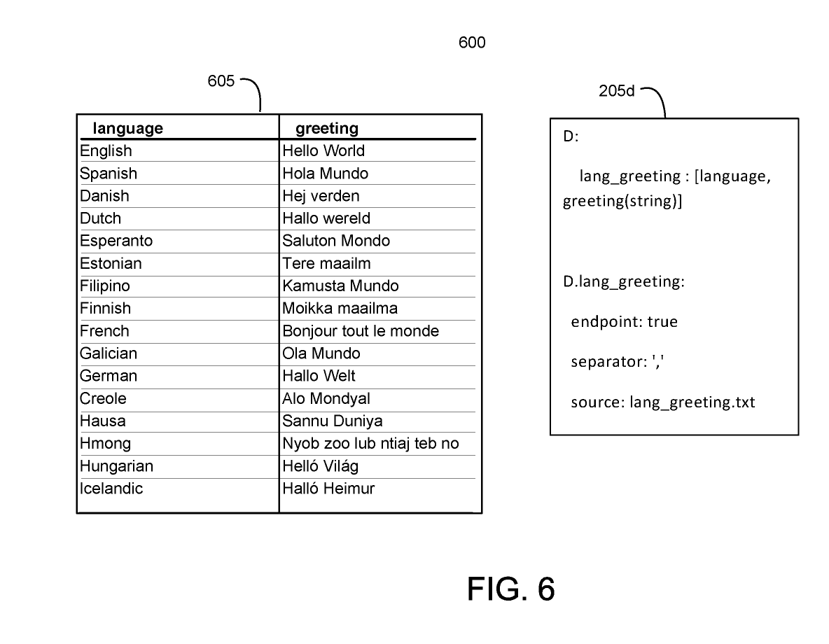

FIG. 6 depicts the example view 600 that includes the text file data structure 205d (e.g., a YAML file data structure) and the display 605. In this example, the end user with declarative programming language capabilities can provide input to the end user computing device 125 to create the text file data structure that calls for a structured representation of greetings in various languages, e.g., in the form of display 605.

Based on the flow text file data structure 205d, the analytics platform appliance 110 can identify the transactional source system 130 where data resides physically (e.g., via filenames, a path or other information), as well as which services or applications can be invoked to fetch or retrieve the data (e.g., FTP, JDBC, REST or other services or applications), and the format of the data (e.g., csv, json, xml, unstructured or other formats). Based on these parameters, the analytics platform appliance 110 or component thereof can retrieve the data from the transactional source system 130 or other database.

At least part of the view 600, such as the display 605 or the text file data structure 205d, can be part of the browser interface dashboard can be displayed within a browser program of the end user computing device 125 and can include the flow text file data structure 205d, e.g., a YAML or other declarative file data structure having declarative commands to obtain a structured representation of greetings in various languages, for example. The example flow text file data structure 205d is reproduced below:

```
D:
      lang_greeting : [language, greeting(string)]
D.lang_greeting:
      endpoint: true
      separator: ‘,’
      source: lang_greeting.txt
```

The text file data structures 205a-d and the displays 305, 405, 505, and 605 are examples, and many other text file data structures 205 and displays are possible. The text file data structures 205a-d are not necessarily complete text file data structures. For example, an end user may want structured representations of display data (e.g., displays 305, 405, 505, 605) that provide television audience engagement analytics that indicate an accurate representation of viewership numbers of one or more television programs. The transactional source systems 130 can include panel data, set top box data, smart TV or internet TV data, or other sources. The end user computing device 125 under end user control can generate the flow text file data structure 205 in a browser interface (e.g., a dashboard). The flow text file data structure 205 can include the information (e.g., indication of source data, data attributes, presentation data instructions, and other data attributes) that, when executed by the intermediary computing device 105, instructs the analytics platform appliance 110 (e.g., any of the data extraction mechanism 140, the data transform mechanism 145, the data load mechanism 150, or the widget generation appliance 115) to obtain source data structures, transform them into the data model structure, identify presentation data instructions, generate the display data structure and provide the corresponding display for rendering by the end user computing device 125.

In another example, an end user may want structured representations of display data from source data about patients, diseases, and hospitals to identify a hospital suitable for a clinical trial of a drug. Or the end user may want structured representations of display data to understand viewership patterns of internet based video streaming platforms. In these and a wide variety of other end use examples, the end user computing device 125 can establish at least one session with the intermediary computing device 105 via the computer network 135. During these sessions, the end user computing device 125 can create and provide a YAML text file or other flow text file data structure 205, for example within a browser interface platform rendered at the end user computing device 125. From, for example, declarative instructions in the flow text file data structure 205, the intermediary computing device 105 can obtain various structured or unstructured source data structures, convert formats, create data models, identify presentation data instructions, and create data display structures and provide the data display structures or the corresponding display for rendering at the end user computing device 125.

The intermediary computing device 105 can receive or obtain the text file data structure 205 from the end user computing device 125. For example, based exclusively on the text file data structure 205, the intermediary computing device 105, or component thereof such as the analytics platform appliance 110 can perform extract, transform, or load operations by executing multiple different applications in multiple different formats to obtain the source data structure, generate the model data structure, identify presentation data instructions, and provide the display data structure to cause rendering of the display 405 at the end user computing device 125. In some implementations, the end user computing device 125 does not have hardware or software capabilities to execute the applications that perform the extract, transfer, or load operations. For example, the end user computing device 125 may not have downloaded or installed applications or programs that perform the extract, transfer, load, or display rendering operations (e.g., dashboard reports or complex visualization), or the end user computing device 125 may not have sufficient hardware (e.g., processing power or memory) to perform the above operations. Instead, the intermediary computing device 105 can perform these operations (e.g., remotely from the end user computing device). In these examples, the end user computing device 125 generates the flow text file data structure 205 and renders the display 405, with the relatively more complex data analytics operations performed, based on information obtained from the flow text file data structure 205, remotely.

The flow text data structure 205 can include a data section that represents a data element, a task section that presents operations to be performed on the data element, a flow section that represents series of tasks to be performed on respective data elements, a layout section that indicates a logical representation of the user interface, or a widget section that represents what widgets should be shown in which layout section and what data is associated with the widgets. The intermediary computing device 105 can convert the data, task, and flow sections of the flow text data structure 205 to Pig source code that gets executed on a Hadoop platform that provides many operators (tasks), such as like GroupBy, FilterBy, OrderBy, join, or aggregate, for example. The intermediary computing device 105 can also generate Spark, SQL, JavaScript, or Streaming code that can be executed in Hadoop or other environments.

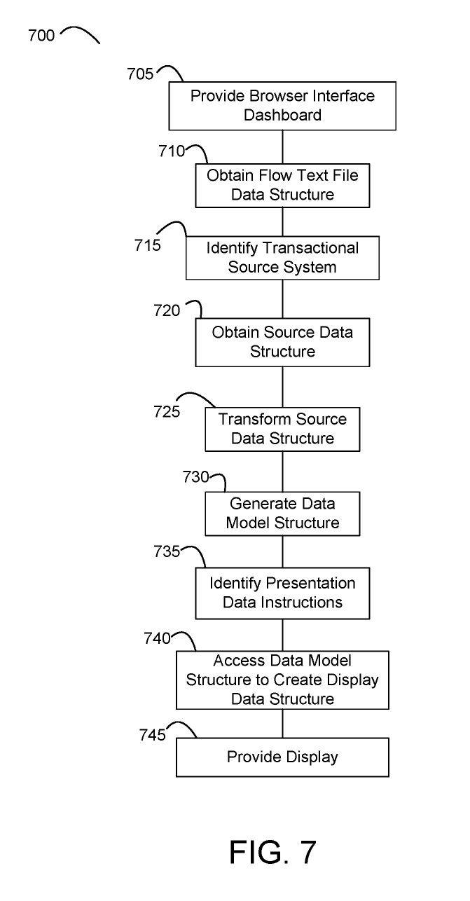

FIG. 7 is a flow diagram depicting an example method 700 of enhancing data analytics operations. The method 700 can include providing a browser interface dashboard (ACT 705). For example, the intermediary computing device 105 can provide a browser interface dashboard for display by the end user computing device 125 (ACT 705) during at least one communication session via the computer network 105. The browser interface dashboard can include an interface used by the end user to create the flow text file data structure 205 and to display representations of the display data structures (e.g., displays 305, 405, 505, or 605 among others). The method 700 can include obtaining the flow text file data structure 205 (ACT 710). For example, the intermediary computing device 105 or component thereof such as the analytics platform appliance 140 can obtain the flow text file data structure 205 from the end user computing device 125 via the computer network 135. For example, the flow text file data structure 205 can be obtained (ACT 710) by the analytics platform appliance 110 directly from the end user computing device 125 via the computer network 135, or the flow text file data structure 205 can be provided to the database 120, where it can be retrieved or accessed by the analytics platform appliance 110. In some implementations, the analytics platform appliance 110 generates the flow text file data structure 205, rather than receiving it from the end user computing device 125. For example, the analytics platform appliance 110 can generate the flow text file data structure 205 from historical data, patterns of use, or available data sets. This information can be stored in the database 120 or obtained from the transactional source system 130, or from other sources such as memory of the end user computing device 125.

The method 700 can include identifying the transactional source system 130 (ACT 715). For example, the analytics platform appliance 110 can parse, evaluate, or execute the flow text file data structure 205 to identify source data, potential source data, types of source data, or transactional source systems 130 that include source or potential source data. The flow text file data structure 205 can directly identify source data structures, or can identify types of source data and the analytics platform appliance can identify specific transactional source systems 130 via the computer network 135 that match or include the types of source data identified in the flow text file data structure. The method 700 can include obtaining the flow text file data structure 205 (ACT 720). For example, the data extraction mechanism 140 (or other intermediary computing device 105 component) can access, copy, or extract source data structures in one or more different formats from one or more transactional source systems 130. The extracted source data structures can be stored in the database 120.

The method 700 can include transforming the source data structure (ACT 725). For example, the data transform mechanism 145, based on the information in the text file data structure 205, the data model structure, or the presentation data instructions, can execute either on the intermediary computing device 105 or on the end user computing device 125 to transform the source data structure into a different format, or into structured data. For example, based on the flow text file data structure 205, the data transform mechanism can generate transformations (e.g., Filterby, Groupby, Condition, Join or other operations) that convert data from one form to another.

The method 700 can include generating the data model structure (ACT 730). For example, the data transform mechanism 145 (or other intermediary computing device 105 component) can generate the source data structure from the transformed data that was transformed from the source data structure, into a model data structure having a common or uniform format or structure. The method 700 can include identifying presentation data instructions (ACT 735). For example, from the flow text file data structure 205, the intermediary computing device 105 (e.g., a component of the analytics platform appliance 110 or the widget generation appliance 115) can obtain or identify from the flow text file data structure 205 a declarative instruction for a type of presentation or display. Presentation data instructions can include or indicate a widget selection such as a line chart, column range histogram, bubble chart, or other structured visual chart, graph, or representation for rendering at the end user computing device 125. The data model structure can be configured for rendering in accordance with the presentation data instructions.

The method 700 can include accessing the data model structure to create the display data structure (ACT 740). For example, the data load mechanism 150, widget generation appliance 115, or other intermediary computing device 105 component can create, from the data model structure, the display data structure that, when rendered at the end user computing device 125 (e.g., within a browser interface platform) displays widgets such as charts, graphs, visual representations, or other structured representations of data. The method 700 can include providing the display (ACT 745). For example, the intermediary computing device 105 can provide the display data structure to the end user computing device 125 for rendering by the end user computing device 125. The display data structure can include or identify a widget (e.g., chart, plot or graph) that represents data in a structured format from which an end user can identify patterns, results, or conclusions. For example, the display data structure can cause display at the end user computing device 125 of one of displays 305, 405, 505, or 605 (or other displays). The display data structure can be part of a file, application or program that can be executed by the intermediary computing device 105 or by the end user computing device 125 for rendering at the end user computing device 125. When the file, application or program that include the display data structure is executed by the intermediary computing device 125, the display can be provided via the computer network 135 to the end user computing device 125 for rendering at the end user computing device 125.

The display data structure (that includes or creates a corresponding display of a widget) can be rendered within a browser interface that executes at the end user computing device 125, such as within a browser interface dashboard display. In this example, the end user computing device 125 can have an installed browser program and does not have an installed dedicated or specific data analytics program. For example, in addition to an operating system and associated functionality, via only a browser application the end user computing device 125 can request (via the flow text file data structure 205) and display associated widgets without locally downloading, installing or executing dedicated data analytics applications.

The devices, systems, and methods described herein are generally directed to development of end to end analytics applications that provide a technical solution to data gathering and organizational problems by using a single platform (e.g., a single text file such as the flow text file data structure 205) to analyze data from a variety of different sources (e.g. transactional source systems 130) and provide the data in a useable format (e.g., displays 305, 405, 505, 605) from which actionable information can be gleaned.

A data processing system such as the intermediary computing device 105 can include computer programs that apply statistical or other operations or analysis to a volume of data in order to organize or describe the data. The analytics platform appliance 110 can include at least one analytics application that includes three distinct components, e.g. an ETL (Extract, Transform, Load) component (e.g., the data extraction mechanism 140, the data transform mechanism 145, and the data load mechanism 150), a data storage component (e.g., the database 120), and a reporting component (e.g., the widget generation appliance). Each component can require different tools, programming languages, or developers with different skill sets. Therefore each new analytics or enterprise project can involve a mix of technology and developers with different skill sets, which can add to the cost and interdependency of a data analytics solution.

For example, the ETL component can include SQL, PI-SQL, scripting languages, or other data integration tools. The data storage component can include spreadsheet applications, flat files, data warehouse or enterprise data warehouse systems, big data, or appliance based databases. The reporting component can include java script based reports, business intelligence or predictive analytics reports, excel files, JasperReports or other java reporting tools that can generate dynamic content.

The components of the intermediary computing device 105 can include analytics applications that implement, use, or require separate structural design, developer skills, developer environments, hardware requirements or deployment strategies. The different components of an analytics application can change the structure or representation of the data, possibly necessitating separate design and implementation of each component or design layer of the analytics application. For example, a change in the existing code can result in a need to go through the evaluation of all three components or layers to determine or remedy the impact of the change. In another example, various tools used in analytics applications can maintain their own metadata so that code merging or other integrations can become more complicated. These and other interdependencies can consume time and resources.

The systems, devices, and methods described herein can include data analytics solutions implemented on a single platform that provides the capability to perform end to end analytics. The platform can include the at least one intermediary computing device 105 (e.g., a data processing system one or more servers, client computing devices, desktops, laptops, mobile computing devices, smartphones, or tablet computing devices) that can develop or provide a complete analytics application using, for example, a single flow file in a single language such as the flow text file data structure 205. The intermediary device 105 devices can communicate via the computer network 135 such as the internet or another computer network. For example, the flow text file data structure 205 can be installed, stored, accessed, or edited at the intermediary computing device (e.g., a central server) or the end user computing device 125 using a YAML or other programming language to develop the ETL and other components of the analytics application. The flow text file data structure for example executing in a browser of the end user computing device 125 can generate code for local execution by the end user computing device 125 or for remote execution by one or more intermediary computing device 105 (e.g., a server or other computing device connected with the end user computing device 125 via computer network 135.

The flow text file data structure 205 can include a text file, where a developer or other user can write YAML code. The flow text file data structure 205 can be created at the end user computing device 125 using a web-based editor. In some implementations, the developer can code via a browser installed on the end user computing device 125. The flow text file data structure 205 can be saved locally at the end user computing device 125 or at the back-end by the intermediary computing device 105 (e.g., in the database 120). Each save operation of the flow text file data structure 205 can create a new copy of the flow text file data structure 205 in the source control system (e.g., the database 120 associated with the intermediary computing device 105).

The flow text file data structure 205 can be compiled at the back-end by the intermediary computing device 105 or component thereof such as the analytics platform appliance. Compilation of the flow text file data structure 205 by the intermediary computing device 105 can include generation of the Pig code and Java Script code that perform data processing and data visualization respectively. For example, the intermediary computing device 105 can run PIG Scripts on Hadoop. The underlying platform implementation of the intermediary computing device 105 can change and the flow text file data structure 205 (e.g., including YAML or other scripts) can still be analyzed to perform data analytics operations and provide the display (e.g., display 305, 405, 505, or 605, among others).

In some implementations, the intermediary computing device 105 (or component such as the analytics platform appliance 110) can include a Pig or MapReduce programming tool, with a Hadoop framework used to execute the data analysis pipeline (e.g., from source to display). The display data structure or other data that gets displayed by the end user computing device 125 (e.g., on dashboards) can be stored in PostgreSQL (or Postgres) or other relational database management system, and visualization can be accomplished using JavaScript or a third party tool such as HighCharts. A developer or other end user can create a copy of the dashboard to fork, modify, create a new dashboard, or update the dashboard. Code from the modified dashboard can also be incorporated back into the original dashboard.

In some examples, when the end user executes the flow text file data structure 205, data processing can be done at or by the intermediary computing device 105 (e.g., at the back-end by one or more servers) and visualization of the display data structure can be done at or by the browser of the end user computing device 125. However, in some examples all or some of the data processing can also be done via the browser by the end user computing device 125 executing the browser.

The end user computing device 125, responsive to end user input, can extend existing flow text file data structures 205 using fork or save as operations. This can cause the analytics platform appliance 110 to create another copy of the flow text file data structure 205 and the end user (e.g., a developer) can extend or change the existing dashboard displayed in the browser of the end user computing device 125. This capability of the analytics platform appliance 110 provides an advantage to the end user because such modifications for an end-to-end data analytics pipeline are not easily possible with conventional industry tools.

The flow text file data structure 205 can be browser based, executing for example in a web browser of the end user computing device 125 and the programming interface can be a text file to facilitate merge, integrate, extend, share, review, or code maintenance operations. For example, the flow text file data structure 205 can be accessed via the “Edit” toolbar interface (or other interface) of a web browser. The flow text file data structure 205 (or the data processing system executing the flow file) can provide abstraction over hardware and software layers, hiding underlying implementation details and hardware or software requirements from the end user. In this example, the end user need not be concerned with whether or not the underlying data (e.g., the source data structure) is obtained from a database or from one or more big data sources, reducing development time.

The flow text file data structure 205 can support multiple data sources, such as java script object notation formats, character separated values (CSV) formats, HTTP, or database formats, as well as a variety of reporting widgets (e.g., various visualizations of data). The flow text file data structure 205 can support end user computing devices 125 such as consumer computing devices, web enabled computing devices, tablet computing devices, or smartphones for visualization of data and for running or executing the analytics platform that includes the flow text file data structure 205 using hardware and software of the end user computing device 125. The flow text file data structure 205 can also be executed remotely by the intermediary computing device 105 (e.g. in a server at a data center) with visualization data provided as output to the end user computing device 125 (e.g., smartphone, laptop, or tablet, etc.) for rendering at the end user computing device 125.

The intermediary computing device 105 (e.g., a data processing system or platform executing the flow text file data structure 205) can help organizations make sense out of a large volume (e.g., terabytes, hundreds or terabytes or more) of or their own data or of third party data. For example, the flow text file data structure 205 can summarize large volumes of structured or unstructured data into one or more visualizations (e.g., widgets) from which trends, performance metrics, insights, or conclusions can be identified. The flow text file data structure 205 can run in a web browser. The intermediary computing device 105 including the analytics platform appliance provides a platform for data gathering from a plurality of sources, such as public sources, enterprise sources, text files, or database collections for example. In some implementations the end user (e.g., a developer or customer) already has the data available however due for example to the volume of the data the developer may be unable to effectively organize or display the data in a meaningful way from which factual or statistical conclusions may be drawn without the use of the analytics platform appliance 110 and flow text file data structure 205 described herein.

Regarding data collection, e.g., from the transactional source system 130, in some examples the analytics platform appliance 110 does not make assumptions about the data. Instead, for example, the analytics platform appliance 110 can support specific sets of formats (e.g., excel, csv, json, xml and other file formats). The analytics platform appliance 110 can provide connectors to read this data from a disk, webservice, REST (representational state transfer), or databases including the database 120 and databases or the transactional source system 130, for example. The end user can manage where and how data is stored. But if data is available in the above mentioned or other formats and can be read using the connectors, data can be made available for processing. The data can be made available via an internal system (e.g., management information systems or an employee management system). In this example, connector framework of the system 100 or of the intermediary computing device 105 can be extended to develop a specific connector to obtain data from specific systems.

In some examples, an organization may seek to analyze high volumes (e.g., terabytes or more) of structured or unstructured data to determine, e.g., whether or not social media or other data indicates that their product is performing well or poorly. A computing device associated with the organization can execute (e.g., the intermediary computing device 105 alone or with servers or other computing devices) the flow text file data structure 205 to analyze data in a variety of different formats (e.g., text, audio, or video), at a high volume (e.g., millions of mentions of the product on social media outlets, web pages, or other electronic documents), and at a high velocity (e.g., rapidly trending or viral topics that can grow at a rate of more than one million instances per week). The flow text file data structure 205, e.g., in YAML or a markup language, can be programmed to aggregate the various data sources, process the sources (e.g., filter, rank, or tag) the data, analyze the data (e.g., by creating various reports) and generate visualizations of the data (widgets) such as charts or graphs based on one or more reports). The data can be aggregated from various third party database or sources (e.g., the transactional source systems 130) such as databases associated with a social network, and the visualizations (widgets) can be created using Java scripts. The visualizations (displays) can indicate conclusions or trends that were previously unknown to the organization.

The devices, systems and methods described herein can simplify development of entire analytics processes using a single text file (e.g., the flow text file data structure 205) to analyze source data structures emanating from a variety of data sources (e.g., the transaction source systems 130). The source data structures can include structured data (e.g., census reports, demographics data, healthcare spending data, organized data) or unstructured data (e.g., text files, documents, weblogs, email data), from various different data sources. The end user can design and implement the entire pipeline using for example a single YAML file (the flow text file data structure 205). The flow text file data structure 205 can provide support to develop data transformation, storage and reporting requirements. These operations can performed on a data processing system such as the analytics platform appliance 110 of the intermediary computing device 105.

An analytics application can include three distinct components—ETL, Data Storage, Reporting. Each component may require a different programming language or developers with different skill sets. The data processing system platform described herein (e.g., the intermediary computing device 105 and components) can reduce or eliminate the need for different programming languages for different components at the end user computing device 125. For example, the intermediary computing device 105 including the analytics platform appliance can support a single programming language to perform all activities required to perform analytics, providing certain technical advantages. For example, the programming interface (e.g., within the browser of the end user computing device 125) can include the flow text file data structure 205 such as a YAML file or other text file. The browser based development workflow at the end user computing device 125 can result in a near zero footprint for the end user. The analytics platform appliance 110 and other intermediary computing device 105 components can provide repeatable remote execution from the end user computing device 125 (e.g., at the intermediary computing device 105) to hide or remove underlying hardware or software implementation details and requirements from the end user computing device 125, regardless of the type or source of the data.

The platform provided by the intermediary computing device 105 and the flow text file data structure 205 executed thereby and described herein can use a single language for analytics related work, (e.g., YAML). This can reduce the need for different technologies at the end user computing device or different skill sets by the end user. Further, display of the display data structure (e.g., displays 305, 405, 505, 605, among others) can occur in several hours or less, such as less than 8 hours from receipt by the intermediary computing device 105 of the flow text file data structure 205. The intermediary computing device 105 having components including the analytics platform appliance 110 and the widget generation appliance 115 offers a technical solution that can break-down the semantics of a data warehouse application. The analytics platform appliance 110 can include a design of a data warehouse or Hadoop based data storage. Then, reporting (e.g., display associated with the display data structure) can be done on top of the data warehouse or Hadoop based data storage. In this example, the design of the data analytics pipeline from transactional source system 130 to the end user computing device 125 via the intermediary computing device 105 using the analytics platform appliance 110 can be changed and simplified. For example, instead of designing a data warehouse and then widgets, visualizations, or reports, the end user using the platform described herein can check what the reporting requirements are, and can transform existing data to match the requirements. This can reduce the development effort needed to create an analytics system or display results.

The intermediary computing device 105 executing a data analytics platform via the analytics platform appliance 110 or widget generation appliance 115 can read data into elements. For example, the intermediary computing device 105 can supports data read in various formats and from various services. After the data (e.g., the source data structure) is read, it can be represented using a data element. For example, supported formats include: XML, CSV, JSON (Java Script Object Notation), or Flat Files with separators. The analytics platform appliance 110 can connect to services or storage such as Files on Disk, REST (Representational State Transfer) API, or Database using JDBC (Java Database Connectivity), to access data such as the source data structure, data model structure, or display data structure.

The intermediary computing device 105 executing a data analytics platform via the analytics platform appliance 110 or widget generation appliance 115 can provide support of Flow and Tasks. Each flow can start with one or more data elements followed by tasks that transform the data. Such tasks can be separated by the pipe “|” character. The output of a previous task can be input to the next task. Also, at the end of the flow the final transformed data can be made available via a name into a data element for display by the end user computing device 125.

The intermediary computing device 105 or component thereof such as the analytics platform appliance 110 can publish command can be used to save data elements for future use. Published Data elements can be used in same flow text file data structure 205 or another flow text file data structure 205 deployed on the same intermediary computing device 105 (e.g., a server). This data can be persisted in a Hadoop distributed file system (HDFS). Once the transformations are done, the end user can save the data for reporting needs remotely at the database 120 or locally at the end user computing device 125. This data can be persisted in PostgreSQL or other object-relational database management system. Note that the volume of this data can be small, e.g., in the gigabyte range or less than 500 GB.

The flow text file data structure 205 (e.g., YAML file) can provides a mechanism to define the layout or visualization of the display data structure. The user interface can include combinations of rows and columns using Layout. Each cell in this grid can contain a widget or another Layout. This provides the end user with flexibility to define the layout. Cells in a grid can be mapped to widgets. The widgets can include various types, such as charts, time series, data grid or other forms of visualization. The platform described herein implemented by the intermediary computing device 105 can provide or include many widgets for selection by the user to visualize the data, e.g., via the widget generation appliance 115.

In some examples, once layouts and widgets are identified or determined by the intermediary computing device 105, and data elements are defined (e.g., from the source data structure), the intermediary computing device 105 can determine which data element can be represented using which widget. The widget generation appliance 115 or other analytics platform appliance 110 component such as the data transform mechanism 145 can associate data elements (e.g., of the data model structure) to widgets. There can also be transformations while assigning data to widget. For example, the data transform mechanism 145 can transform data formats to associate data to widgets for display. This provides the end users with flexibility to apply filters based on selections of other widgets.

The analytics platform of the intermediary computing device 105 can provide or obtain a single flow text file data structure 205 (e.g., YAML file) to write the entire analytics pipeline. During the development of an analytics application (e.g., to generate visualizations from a large amount of data), the end user focuses on what to do rather on how to do it. When the flow text file data structure 205 is compiled and executed on the analytics platform described herein (e.g., by the intermediary computing device 105 including one or more servers alone or in conjunction with a networked client computing device), the flow text file data structure 205 can run the analytics operations on the underlying platform (e.g., server-based Hadoop) and the reporting of results (e.g., displays 305, 405, 505, 605, among others) can be done on the browser executing at the end user computing device 125. In this example, the data input, data processing, and data representation operations can be done in or by execution of the flow text file data structure 205. One advantage of this platform is that the underlying implementation may change, for example from Pig to some other technology, or reporting done using Javascript may change to use a different tool, in a way that is transparent to or not noticed by the end user (e.g., at the end user computing device 125 with the browser). In this example, the end user can still implement the flow text file data structure 205 using YAML only. From an end user perspective this results in a simplified end user or developer interface whereby operational knowledge of a single YAML file (or other language) can be used to implement and end-to-end big data analytics operation.

Once the analysis is complete, analyzed data can get persisted at two places. For example, the processed data elements can be persisted on HDFS (Hadoop distributed file system) for the future use. In some examples, a subset of data that is required for visualization can be persisted in a PostgreSQL or other relational database management system.

The layout section and widget section of the flow text file data structure 205 can represent what can be provided by the intermediary computing device 105 for display at the end user computing device 125, e.g., in the dashboard of a browser. The display data structure can be retrieved from PostgreSQL or another relational database management system, for example by the data load mechanism 150 or the widget generation appliance 115. For example, a JavaScript based online analytical processing (OLAP) cube (Cross-filter) can be generated at the browser, that helps analyze or parse the data at the browser of the end user computing device 125, for example in the absence of communication with the intermediary computing device 105 via the computer network 135. This can provide a quick and seamless end user experience.

In some examples, the above technical details can be hidden from the end user at the end user computing device 125. Based on the changes in the technology or improvements to hardware or software with time, the underlying implementation may change over period of time. However, in this example the flow text file data structure 205 interface can remain the same for the end user, providing compatibility and robustness in the face of under the hood technological developments.

The intermediary computing device 105 and components such as the analytics platform appliance 110, database 120, and the widget generation appliance 115 can include data, storage, and processing capabilities, such as data warehouse solutions, big data based solutions, or appliance based databases. The intermediary computing device 105 and components such as the analytics platform appliance 110, database 120, and the widget generation appliance 115 can report or provide the display data structure for display by querying and reporting data directed from the source (e.g., persisted analyzed data), for example using SQL queries or another form of direct access. The intermediary computing device 105 can also creating in memory (e.g., at the database 120) a representation of a data structure first, and can report or visualize the data as a display using the in-memory data structure, which can be indirectly read from the source (e.g., persisted analyzed data). The intermediary computing device 105 can implement various tools, which may be specialized or proprietary, to accomplish data acquisition, storage, and visualization. Each tool can differentiate from other tools and are specialized into one of these categories.

The analytics platform described herein, implemented by the intermediary computing device 105 in conjunction with the end user computing device 125 can hide many implementation details from the end user so that the end user (e.g., a programmer or developer) does not need specialized database management system capabilities. This creates a framework where based on the problem definition different techniques can be used to provide the displays 305, 405, 505, or 605, among others. Such an analytics platform provides many implementations, such as providing many data source connectors—e.g., read from file, REST (representational state transfer), Webservice, or Database; a number of widgets (e.g., charts, plots, or graphs discussed herein); and task section implementation using e.g., Pig, Java, Python, R, or UDF (user defined field or format). With the analytics platform, developers or other end users can extend existing implementations to suit their needs. For example, the tasks section mentioned above is extensible. End users can extend the task and write custom implementation that suites their problem definition and based on the technique most suitable to them. Developers or other users can use the widget generation appliance 115 to write their own widget (e.g., a visualization of results), for example when a widgets pool of existing widgets (e.g., stored in the database 120 and accessible by the widget generation appliance 115) does not provide a desired feature.

The data analytics platform described herein including the flow text file data structure 205 (e.g., in YAML) can provide a single platform to perform the activities desired for big data analytics. The platform is extensible allowing one or more end users to add features that suit their needs.

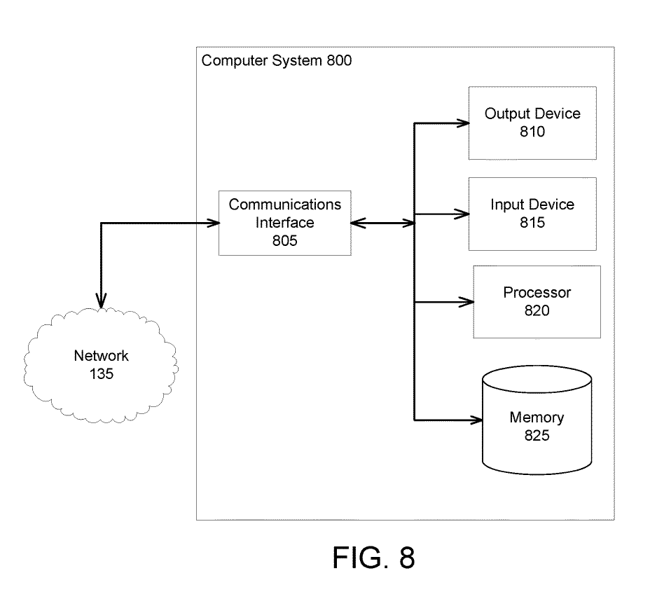

FIG. 8 shows the general architecture of an illustrative computer system 800 that may be employed to implement any of the computer systems discussed herein (including the system 100 and its components such as the intermediary computing device 105, the analytics platform appliance 110, the widget generation appliance 115, and the database 120) in accordance with some implementations. The computer system 800 can be used to provide information via the computer network 135, for example to obtain the source data structure from the transactional source system 130 or to provide the display data structure to the end user computing device 125. The computer system 800 can include one or more processors 820 communicatively coupled to at least one memory 825, one or more communications interfaces 805, one or more output devices 810 (e.g., one or more display units) or one or more input devices 815. The processors 820 can be included in the intermediary computing device 105 or the other components of the system 100 such as the analytics platform appliance 110 or the widget generation appliance 115.

The memory 825 can include computer-readable storage media, and can store computer instructions such as processor-executable instructions for implementing the operations described herein. The intermediary computing device 105, the analytics platform appliance 110, the widget generation appliance 115, or the database 120 can include the memory 825 to obtain or parse the flow text file data structure 205, obtain the source data structure, generate the data model structure, identify presentation data instructions, or create or provide the display data structure, for example. The at least one processor 820 can execute instructions stored in the memory 825 and can read from or write to the memory information processed and or generated pursuant to execution of the instructions.

The processors 820 can be communicatively coupled to or control the at least one communications interface 805 to transmit or receive information pursuant to execution of instructions. For example, the communications interface 805 can be coupled to a wired or wireless network (e.g., the computer network 135), bus, or other communication means and can allow the computer system 800 to transmit information to or receive information from other devices (e.g., other computer systems such as the transactional source system 130 or the end user computing device 125). One or more communications interfaces 805 can facilitate information flow between the components of the system 100. In some implementations, the communications interface 805 can (e.g., via hardware components or software components) to provide a website or browser interface as an access portal or platform to at least some aspects of the computer system 800 or system 100. Examples of communications interfaces 805 include user interfaces.

The output devices 810 can allow information to be viewed or perceived in connection with execution of the instructions. The input devices 815 can allow a user to make manual adjustments, make selections, enter data or other information e.g., a YAML file or other flow text file data structure 205, or interact in any of a variety of manners with the processor 820 during execution of the instructions.

The subject matter and the operations described herein can be implemented in digital electronic circuitry, or in computer software, firmware, or hardware, including the structures disclosed in this specification and their structural equivalents, or in combinations of one or more of them. The subject matter described in this specification can be implemented at least in part as one or more computer programs, e.g., computer program instructions encoded on computer storage medium for execution by, or to control the operation of, the intermediary device 105 or the end user computing device 125, for example. The program instructions can be encoded on an artificially-generated propagated signal, e.g., a machine-generated electrical, optical, or electromagnetic signal that is generated to encode information (e.g., the flow text file data structure 205) for transmission to suitable receiver apparatus for execution by a data processing system or apparatus (e.g., the analytics platform appliance 110 or components thereof). A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described herein can be implemented as operations performed by a data processing apparatus (e.g., the intermediary computing device 105) on data stored on one or more computer-readable storage devices or received from other sources (e.g., the flow text file data structure 205 received from the end user computing device 125).

The terms “data processing system” “computing device” “appliance” “mechanism” or “component” encompasses apparatuses, devices, and machines for processing data, including by way of example a programmable processor, a computer, a system on a chip, or multiple ones, or combinations, of the foregoing. The apparatuses can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination thereof. The apparatus and execution environment can realize various different computing model infrastructures, such as web services, distributed computing and grid computing infrastructures. The intermediary computing device 105 can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more components, sub-programs, or portions of code that may be collectively referred to as a file). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the intermediary computing device 105) to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

The subject matter described herein can be implemented, e.g., by the intermediary computing device 105, in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or a combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the internet), and peer-to-peer networks (e.g., ad hoc peer-to-peer networks).

The computing system such as system 100 or system 800 can include clients and servers. A client and server are generally remote from each other and typically interact through a communication network (e.g., the network 105). The relationship of client and server arises by virtue of computer programs running on the respective computers and having a client-server relationship to each other. In some implementations, a server transmits data (e.g., an HTML page, the display data structure, or the flow text file data structure 205) to a client device (e.g., for purposes of displaying data to and receiving user input from a user interacting with the client device). Data generated at the client device (e.g., a result of the user interaction) can be received from the client device at the server (e.g., received by the intermediary computing device 105 from the transactional source system 130 or from the end user computing device 125).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware, combination hardware-software, or software product. For example, the intermediary computing device 105, the analytics platform appliance 110, or the widget generation appliance 115 can be a single component, device, or a logic device having one or more processing circuits, or part of one or more servers of the system 100.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems, devices, or methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. For example, references to the intermediary computing device 105 can include references to multiple physical computing devices (e.g., servers) that collectively operate to form the intermediary computing device 105. References to any act or element being based on any information, act or element may include implementations where the act or element is based at least in part on any information, act, or element.

Any implementation disclosed herein may be combined with any other implementation or embodiment, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An intermediary computing device disposed in a data communications path between a transactional source system and an end user computing device that enhances data analytics operations, the intermediary computing device comprising:
an analytics platform appliance that includes a data extraction mechanism, a data transform mechanism, and a data load mechanism;
the analytics platform appliance obtains, from the end user computing device, a flow text file data structure;
the analytics platform appliance parses the flow text file data structure to identify the transactional source system;
the data extraction mechanism obtains, from the transactional source system and based on information in the flow text file data structure, a source data structure;
the data transform mechanism generates, based on information in the flow text file data structure, a data model structure from the source data structure and stores the data model structure in a database;
the analytics platform appliance identifies, from the flow text file data structure obtained from the end user computing device, presentation data instructions;
the data load mechanism accesses the data model structure from the database and creates a display data structure based on the presentation data instructions identified from the flow text file data structure; and
the intermediary computing device provides the display data structure to the end user computing device.

2. The intermediary computing device of claim 1, wherein the analytics platform appliance obtains the flow text file data structure via a plurality of separate communication instances between the intermediary computing device and the end user computing device.

3. The intermediary computing device of claim 1, comprising:
the analytics platform appliance obtains the flow text file data structure via a browser interface of the end user computing device.

4. The intermediary device of claim 1, comprising:
the intermediary computing device provides the display data structure to the end user computing device for display in a browser interface of the end user computing device.

5. The intermediary device of claim 1, wherein the analytics platform appliance provides a browser interface dashboard for display by the end user computing device, and the analytics platform appliance obtains the flow text file data structure from the end user computing device via the browser interface dashboard.

6. The intermediary device of claim 1, wherein the analytics platform appliance executes a browser interface dashboard application to display a browser interface dashboard at the end user computing device, and the analytics platform appliance obtains the flow text file data structure from the end user computing device via the browser interface dashboard.

7. The intermediary device of claim 1, wherein the analytics platform appliance provides a browser interface dashboard for display by the end user computing device, and the analytics platform appliance provides the display data structure to the end user computing device for display by the end user computing device within the browser interface dashboard.

8. The intermediary computing device of claim 1, wherein the intermediary computing device provides the display data structure instructions to the end user computing device for display by the end user computing device in a display with a graphical component juxtaposed with a portion of the text file data structure.

9. The intermediary computing device of claim 1, wherein the flow text file data structure includes at least one of a declarative code data structure and a YAML file data structure.

10. The intermediary computing device of claim 1, wherein the flow text file data structure includes data in a first format, and the analytics platform appliance generates, from the flow text file data structure in the first format, at least one executable instruction in a second format.

11. The intermediary computing device of claim 10, wherein the data load mechanism executes the at least one executable instruction in the second format to create the display data structure.

12. The intermediary device of claim 1, wherein the source data structure includes a plurality of heterogeneous data structures, comprising:
the data extraction mechanism obtains, from the transactional source system, based on information in the flow text file data structure, a first heterogeneous data structure in a first format;
the data extraction mechanism obtains, from the transactional source system, based on information in the flow text file data structure, a second heterogeneous data structure in a second format; and
the data transform mechanism generates, based on information in the text file data structure, the data model structure from the first heterogeneous data structure in the first format, and from the second heterogeneous data structure in the second format.

13. The intermediary computing device of claim 12, wherein the data transform mechanism executes on the end user computing device.

14. The intermediary computing device of claim 12, wherein the data load mechanism creates the display data structure from the data model structure based on the first heterogeneous data structure in the first format and based on the second heterogeneous data structure in the second format.

15. The intermediary computing device of claim 1, wherein the data transform mechanism generates, based on information in the text file data structure, the data model structure that includes a structured format representation of information obtained from the source data structure.

16. The intermediary computing device of claim 15, wherein information obtained from the source data structure includes heterogeneous data in a plurality of different formats.

17. The intermediary computing device of claim 1, wherein the analytics platform appliance selects a type of data storage based on characteristics of the data model structure.

18. The intermediary computing device of claim 1, wherein the intermediary computing device identifies, from the flow text file data structure, a widget selection and provides the display data structure to the end user computing device based on the widget selection.

19. A method of enhancing data analytics operations with an intermediary computing device that includes an analytics platform appliance and that is disposed in a data communications path between a transactional source system and an end user computing device, comprising:
obtaining, by the analytics platform appliance, from the end user computing device via the data communications path, a flow text file data structure;
identifying, by the analytics platform appliance, from the flow text file data structure, the transactional source system;
obtaining, by the intermediary computing device, from the transactional source system and based on information in the flow text file data structure, a source data structure;
generating, by the intermediary computing device, based on information in the flow text file data structure, a data model structure from the source data structure and stores the data model structure in a database;
identifying, by the intermediary computing device, from the flow text file data structure, presentation data instructions;
accessing the data model structure from the database to create a display data structure based on the presentation data instructions identified from the flow text file data structure; and
providing, by the intermediary computing device, the display data structure to the end user computing device.

20. The method of claim 19, wherein the source data structure includes heterogeneous data structures, comprising:
obtaining, from the transactional source system, based on information in the flow text file data structure, a first heterogeneous data structure in a first format;
obtaining, from the transactional source system, based on information in the flow text file data structure, a second heterogeneous data structure in a second format; and
generating, based on information in the text file data structure, the data model structure from the first heterogeneous data structure in the first format, and from the second heterogeneous data structure in the second format.

21. The method of claim 19, comprising:
obtaining the flow text file data structure via a browser interface of the end user computing device; and
providing the display data structure to the end user computing device for display in a browser interface of the end user computing device.

22. The method of claim 19, wherein the flow text file data structure is a first flow text file data structure, comprising:
generating, by the analytics platform appliance, a second flow text file data structure.
